(19) United States
(12) Patent Application Publication
(10) Pub. No.: US 2004/0264010 A1
(43) Pub. Date: Dec. 30, 2004

(54) Light reflector for personal items

(76) Inventors: Yuan-Chun Mao, Tucheng City (TW); Cheng-Hsin Liu, Tucheng City (TW); Chien-Kang Ho, Tucheng City (TW)

Correspondence Address: Jason Z. LIN, Supreme Patent Services, Post Office Box 2339, Saratoga, CA, 95070-0339, US

(21) Appl. No.: 10/600,126

(22) Filed: Jun. 20, 2003

(51) Int. Cl. G02B 5/08

(52) U.S. Cl. 359/838

(57) ABSTRACT

A light reflector is mounted to a personal item, such as shoe, clothes, and hats. The light reflector includes a light reflective base plate having a surface on which at least one light reflecting cone is formed for reflecting light incident onto the reflector. The light reflector has a light non-transmitting layer formed on a surface thereof except the portion where light transmits into the light reflector. The light non-transmitting layer prevents the reflected light from being randomly dispersed. The cones may be formed of a plurality of flat faces having different angular orientations whereby light is reflected in such a way to provide shining and glaring effect.

### BACKGROUND OF THE INVENTION

1. Field of the Invention

The present invention relates generally to personal warning device, and in particular to a light reflector to be mounted to a personal item or formed as a personal item to be carried by a person.

2. The Related Art

People walking or working in dark environments, such as at night, are often hit by fast moving vehicles. To avoid such a situation, workers that work outdoors at night usually wear jackets with reflectors attached thereto. The conventional reflectors are flat devices, such as reflection stickers, which may get off the jackets after long term use. In addition, the reflection sticker may get wrinkled, leading to poor light reflection. Further, regular consumers do not wear such jackets when they walk outdoors at night, which puts their lives in risky condition.

It is thus desired to have a light reflector to overcome the drawbacks of the conventional reflection devices.

### SUMMARY OF THE INVENTION

An object of the present invention is to provide a light reflector for providing personal protection when a person does outdoor activity at night or in dark environments.

Another object of the present invention is to provide a light reflector that provides aesthetic appearance by means of the glaring and shining effect caused by the light reflected thereby.

A further object of the present invention is to provide a light reflector having improved service life and better performance.

Yet a further object of the present invention is to provide a light reflector that allows the reflected light to be directed toward a given direction for enhanced protection to a person wearing the light reflector.

To achieve the above objects, in accordance with the present invention, there is provided a light reflector adapted to be mounted to a personal item, such as shoe, clothes, and hats. The light reflector comprises a light reflective base plate having a surface on which at least one light reflecting cone is formed for reflecting light incident onto the reflector. The direction in which the light is reflected can be changed by properly deforming the cones. The light reflector has a light non-transmitting layer formed on a surface thereof except the portion where light transmits into the light reflector. The light non-transmitting layer prevents the reflected light from being randomly dispersed. The cones may be formed of a plurality of flat faces having different angular orientations whereby light is reflected in such a way to provide shining and glaring effect

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a light reflector constructed in accordance with the present invention;

FIG. 2 is a perspective view similar to FIG. 1 for illustrating the operation of the light reflector of the present invention;

FIG. 3 is an exploded view showing a first application of the light reflector of the present invention;

FIG. 4 is a cross-sectional view of the first application of the light reflector of the present invention, illustrating light reflection thereby;

FIG. 5 is an exploded view showing a second application of the light reflector of the present invention;

FIG. 5A is an enlarged view of encircled portion 5A of FIG. 5;

FIG. 6 is a cross-sectional view of the second application of the light reflector of the present invention illustrating light reflection thereby;

FIG. 7 is a perspective view showing a third application of the light reflector of the present invention;

FIG. 7A is an enlarged view of encircled portion 7A of FIG. 7;

FIG. 8 is a cross-sectional view of the third application of the light reflector of the present invention illustrating light reflection thereof; and

FIG. 8A is an enlarged view of encircled portion 8A of FIG. 8.

### DETAILED DESCRIPTION OF THE PREFERRED EMBODIMENTS

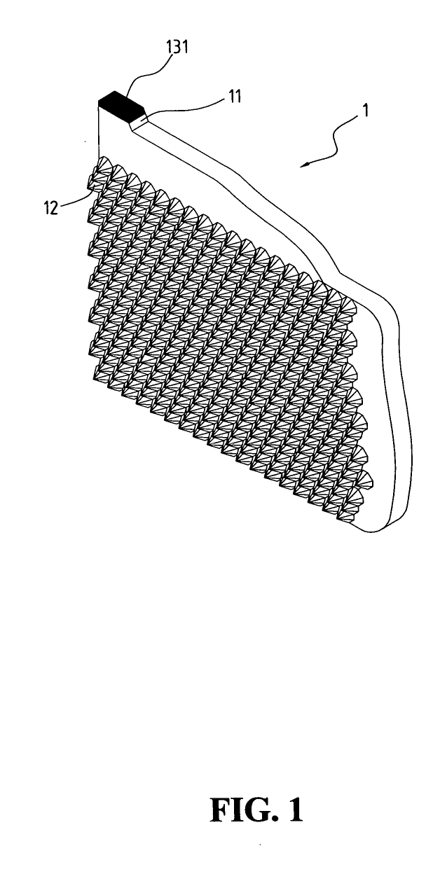

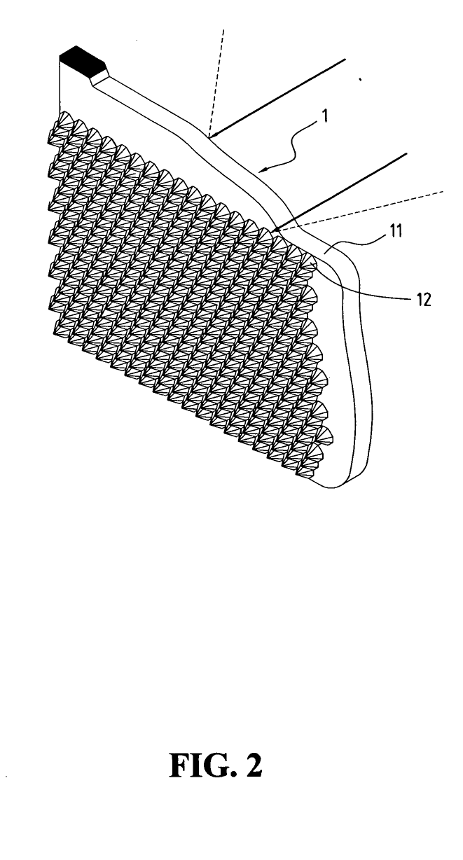

With reference to the drawings and in particular to FIGS. 1 and 2, a light reflector constructed in accordance with the present invention, generally designated with reference numeral 1, comprises a light reflective base plate 11 having a surface (not labeled) on which a plurality of light reflecting cones 12 are formed. In the embodiment illustrated, the cones 12 are arranged in an array. However, the arrangement of the cones 12 may be randomly distributed. Light incident onto the reflector 1, as indicated by character A in FIG. 2, is partially reflected by the base plate 1, as indicated by B, and partially by the cones as indicated by C. To avoid undesired dispersion of the reflected light, a side surface (not labeled) of the base plate 1 is coated with a light non-transmitting layer 131, which prevents the reflected light to leave the reflector 1 through the side surface of the base plate 1 whereby intensity of the reflected light can be maximized in a given direction.

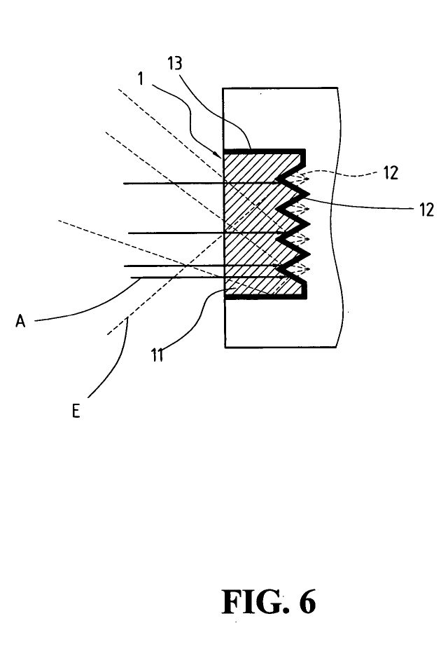

Also referring to FIG. 6, if desired, a side wall (not labeled) is formed to extend along a circumference of the base late 11 so as to surround the cones 12 and define an open end (not labeled) through which light travels toward the cones 12. Alternatively, the base plate 1 forms a cavity having a bottom on which the cones 12 are formed. The cones 12 can be raised above the bottom of the cavity as shown in solid lines or the cones 12 can be recessed as shown in phantom lines. Both are equally effective in reflecting incident light. The light non-transmitting layer 13 is formed on an outside surface of the cones 12 and an inside surface of the side wall whereby light incident onto the cones 12 is prevented from being dispersed sideways and all the reflected light can be concentrated and projected out of the reflector 1 through the open end. This enhances the brightness of the reflected light by the reflector 1.

If desired, each cone 12 can be formed of a number of flat faces (not labeled) orientated at different angles. A more versatile reflection and glaring can be obtained for shining appearance and enhanced warning. Further, the orientation of the flat faces of the cones 12 can be of particular angles for directing the reflected light to a given direction. For example, when the reflector 1 is mounted to a shoe, it is preferred to have the reflected light goes upward for easy identification by others.

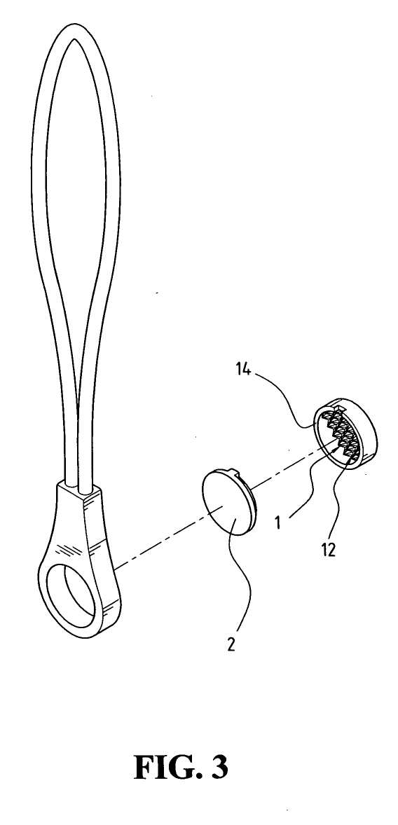

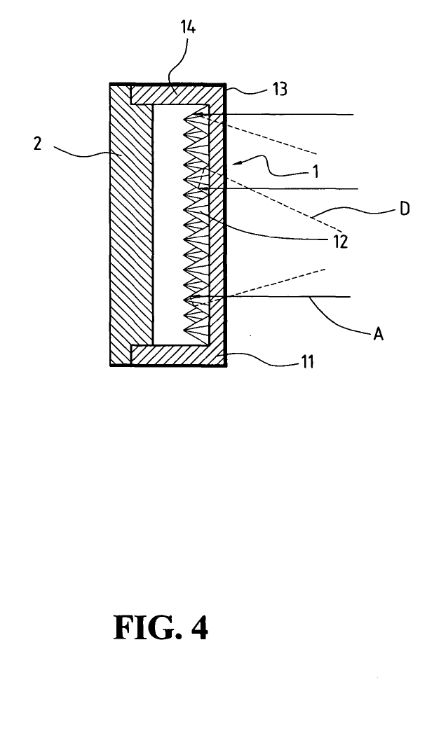

Also referring to FIGS. 3 and 4, the reflector 1 of the present invention can be incorporated with any personal items, for example a pendent illustrated in FIGS. 3 and 4. The reflector 1 comprises a mount wall 14, which helps for mounting to other articles and supports the light non-transmitting layer 13 of the reflector 1. The cones 12 are surrounded by the wall 14. Preferably, a lid 2 selectively closes the open end of the side wall 14 for shielding the cones 12 from external contamination. Light incident onto the reflector, as indicated by A, is reflected by the cones 12 as indicated by D. The light non-transmitting layer 13 is formed on an outside surface of the mount wall 14. Alternatively, the mount wall 14 can be made of a light non-transmitting material and the light non-transmitting layer 13 may be simply omitted. The lid 2 may be made of light transmitting material whereby light is allowed to get onto the cones 12 through the lid 2 or a light non-transmitting material whereby the light is not allowed to project onto the cones 12 through the lid 2.

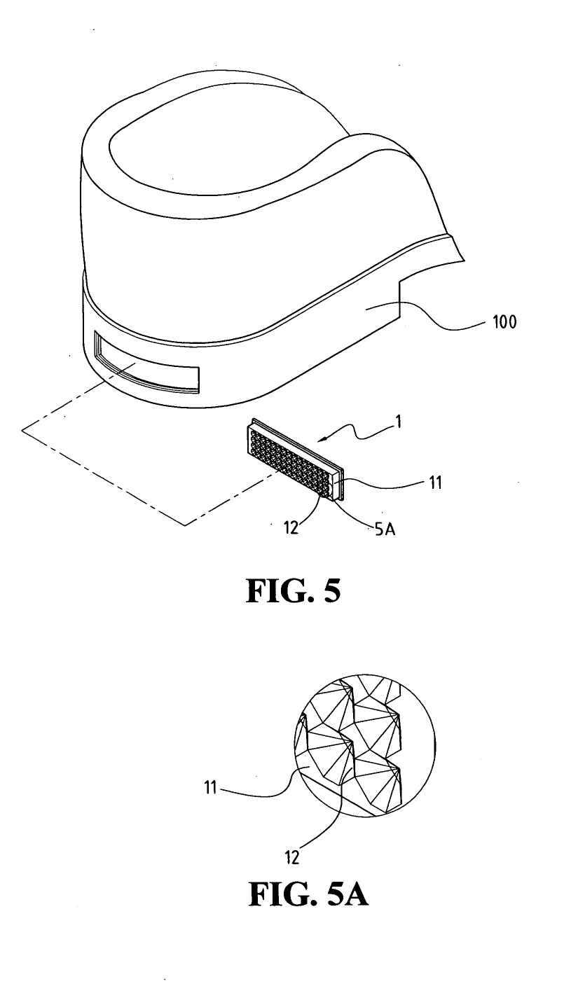

Also referring to FIGS. 5, 5A and 6, the reflector 1 of the present invention is mounted to a shoe 100. To comply with the curved shape of the shoe, the reflector 1 can be made of flexible material whereby the reflector 1 is deformed when being mounted to an arcuate article. Although, the cones 12 are raised from the base plate 11 in the embodiment illustrated, they can be replaced by conic recesses as shown in phantom lines in FIG. 6. When light transmits into the reflector 1, as indicated by A in FIG. 6, the light is reflected by the cones 12 or the conic recesses, as well as the inside surface of the side wall on which the light non-transmitting layer 13 is formed, as indicated by E. Similarly, the recesses can be formed of a plurality of flat faces orientated with different angles, which allows for the intensity of the reflected light to be enhanced in a particular direction, while reduced in other directions.

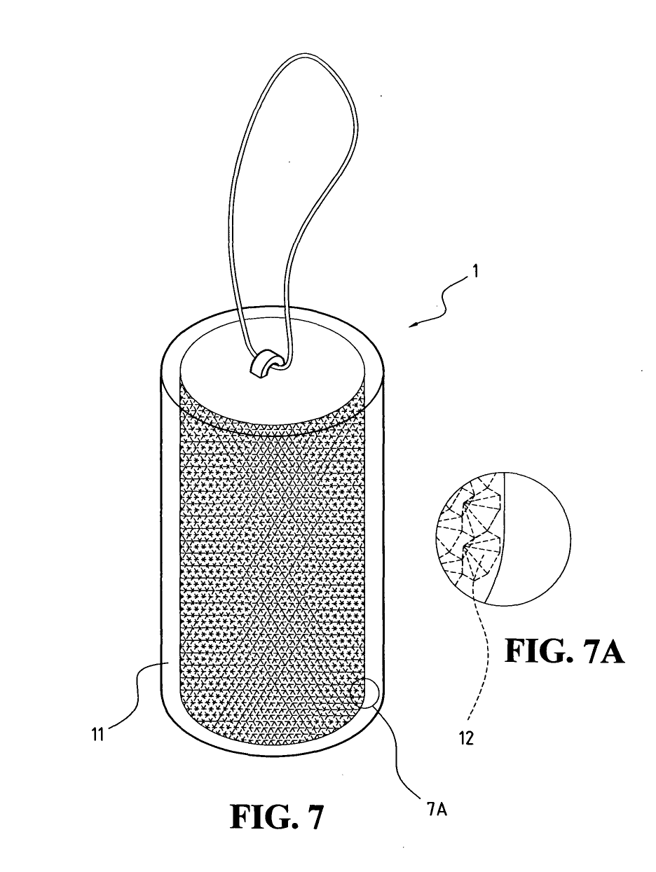

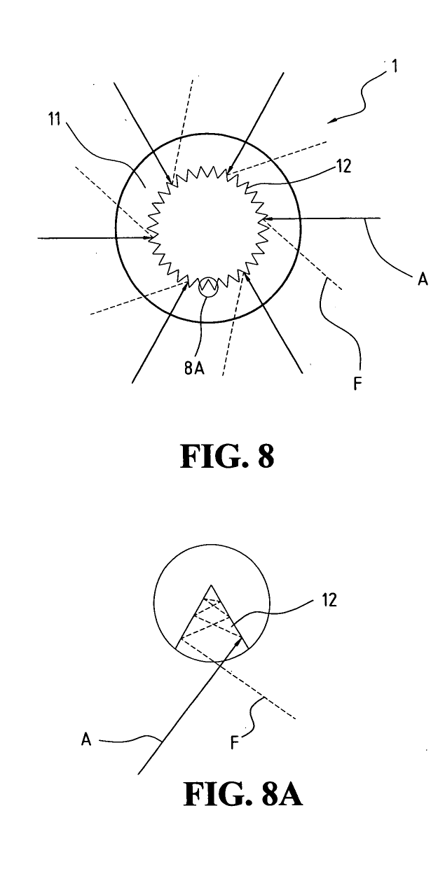

Also referring to FIGS. 7, 7A, 8 and 8A, the reflector 1 is made as a small cylinder to be carried by a person or attached to a personal item. The base plate 1 is bent to form the cylinder having a hollow interior and an inside surface on which the cones 12 are formed. Light incident onto the reflector 1 from an outside surface thereof, as indicated by A, is completely reflected by the cones 12 formed inside the cylinder as indicated by F. Alternatively, the light may undergo multiple reflection by side faces of the cones 12 as shown in FIG. 8A. The inside cones 12 reflect the incident light in a manner similar to a diamond whereby shining and glaring can be obtained.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light reflector for personal items comprising a light reflective base plate on which at least one light reflecting cone is formed.

2. The light reflector as claimed in claim 1, wherein the reflecting cone is raised on a surface of the base plate.

3. The light reflector as claimed in claim 1, wherein the reflecting cone is comprised of a number of flat faces of different angular orientations.

4. The light reflector as claimed in claim 1 further comprising a mount wall extending from the base plate.

5. The light reflector as claimed in claim 1 further comprising a light non-transmitting layer formed on a surface of the reflector.

6. The light reflector as claimed in claim 1 further comprising a circumferential side wall extending from the base plate and forming an open end to which a lid is removably mounted.

7. The light reflector as claimed in claim 7, wherein a light non-transmitting layer is formed on the base plate and the side wall for preventing reflected light to disperse.

8. The light reflector as claimed in claim 1, wherein the base plate is bent to form a cylinder having an inside surface defining an interior space, the cones being formed on the inside surface and located in the interior space.
